(19) United States
(12) Patent Application Publication
(10) Pub. No.: US 2009/0284092 A1
(43) Pub. Date: Nov. 19, 2009

(54) Motor Rotor

(75) Inventors: Alex Horng, Kaohsiung (TW); Chih-Wen Wu, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: Sunonwealth Electric Machine Industry Co., Ltd., Kaohsiung (TW)

(21) Appl. No.: 12/436,942

(22) Filed: May 7, 2009

Related U.S. Application Data
(63) Continuation-in-part of application No. 12/142,864, filed on Jun. 20, 2008.

(30) Foreign Application Priority Data
May 14, 2008 (TW) 097117705

(51) Int. Cl. H02K 1/30; F04D 25/08

(52) U.S. Cl. 310/156.12; 417/354

(57) ABSTRACT

A motor rotor includes a hub, a metal ring and a magnet ring. The hub includes a peripheral wall. The metal ring includes an engaging portion and is formed by bending a strip of metal plate to form a cylindrical ring mounted to an inner surface of the peripheral wall of the hub. The metal plate includes a first positioning portion and a second positioning portion respectively on two ends thereof. The first and second positioning portions are joined together to form the engaging portion. The magnet ring is mounted to an inner radial surface of the metal ring. Accordingly, by configuration of the engaging portion, stable formation of the cylindrical metal ring is assuredly provided.

### CROSS REFERENCE TO RELATED APPLICATION

This is a continuation-in-part application of U.S. patent application Ser. No. 12/142,864 filed on Jun. 20, 2008.

### BACKGROUND OF THE INVENTION

1. Field of the Invention

The present invention relates to a rotor and, more particularly, to a motor rotor that can be coupled to a stator to construct a motor.

2. Description of the Related Art

FIGS. 1 and 2 show a conventional motor rotor 4 including a hub 41 having a shaft 411 mounted to a center thereof, a metal ring 42 mounted to an inner periphery of a radial wall of the hub 41, and a magnet ring 43 mounted to an inner periphery of the metal ring 42. The metal ring 42 has inverted an L-shaped cross section to provide reliable engagement with the hub 41. The metal ring 42 is arranged between the hub 41 and the magnet ring 43 to provide a leakage flux absorbing effect for the magnet ring 43.

However, formation of the metal ring 42 with the inverted L-shaped cross section requires several punching processes to cause troublesome processing and waste of material. Thus, a manufacturing cost of the motor rotor 4 is increased and waste in material is excessive.

Another conventional motor rotor is described in Taiwan Patent Issue No. 490912 entitled “MOTOR ROTOR AND ITS MANUFACTURING METHOD” and shown in FIG. 3. The motor rotor is designated “5” and includes a hub 51, a metal ring 52, and a magnet ring 53. The metal ring 52 is formed by bending a strip of metal plate having a length equal to or slightly smaller than an inner circumference of the hub 51. The metal ring 52 is mounted to the inner periphery of the hub 51 and exerts a radially expanding force to and is thus in tight contact with the inner periphery of the hub 51. Two ends of the magnet ring 53 can be in contact with or spaced from each other. The magnet ring 53 is then tightly attached onto the inner periphery of the metal ring 52.

Formation of the metal ring 52 by bending a strip of metal plate avoids waste of material and provides easy manufacturing to overcome the problems of the conventional motor rotor 4. Nevertheless, the ends of the metal ring 52 are not positioned, and thus the metal ring 52 will be liable to shift in the axial direction of the hub 51 (see FIG. 4). As a result, difficulty in subsequently mounting the magnet ring 53 and rotational instability of the rotor 5 are caused. Hence, there is a need for an improvement over the conventional motor rotor.

### SUMMARY OF THE INVENTION

It is therefore the primary objective of this invention to provide a motor rotor including a metal ring formed by bending a metal plate that includes a first positioning portion and a second positioning portion respectively on two ends thereof for forming an engaging portion of the metal ring to provide enhanced coupling effect, convenience of assembling and quality of the motor rotor.

The second objective of the present invention is to provide a motor rotor that includes the metal ring with a coupling section on the outer radial surface thereof to tightly combine the metal ring with a hub to enhance reliability of combination of the hub and the metal ring.

A motor rotor according to the preferred teachings of the present invention includes a hub, a metal ring and a magnet ring. The hub includes a peripheral wall. The metal ring includes an engaging portion and is formed by bending a strip of metal plate to form a cylindrical ring mounted to an inner surface of the peripheral wall of the hub. The metal plate includes a first positioning portion and a second positioning portion respectively on two ends thereof. The first and second positioning portions are joined together to form the engaging portion. The magnet ring is mounted to an inner radial surface of the metal ring. Accordingly, by configuration of the engaging portion, stable formation of the cylindrical metal ring is assuredly provided.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded, partly-cutaway, perspective view illustrating a conventional motor rotor;

FIG. 2 is a partial, exploded, cross-sectional view illustrating the conventional motor rotor of FIG. 1;

FIG. 3 is an exploded, perspective view illustrating another conventional motor rotor;

FIG. 4 is a partly exploded, perspective view illustrating the conventional motor rotor of FIG. 3 with a hub of the motor rotor partly cutaway to show axial shift of an end of a metal ring of the motor rotor;

FIG. 5 is an exploded, perspective view illustrating a motor rotor of a first embodiment according to the preferred teachings of the present invention;

FIG. 6 is a partly exploded, perspective illustrating the motor rotor of FIG. 5 with a hub of the motor rotor partly cutaway;

FIG. 7 is a stretched out view of a metal plate for forming a metal ring of the motor rotor of FIG. 5;

FIG. 8 is a perspective view of the metal ring of FIG. 5;

FIG. 9 is a stretched out view of another metal plate for forming a metal ring of a motor rotor of a second embodiment according to the preferred teachings of the present invention;

FIG. 10 is a perspective view of the metal ring of FIG. 9;

FIG. 11 is a stretched out view of still another metal plate for forming a metal ring of a motor rotor of a third embodiment according to the preferred teachings of the present invention;

FIG. 12 is a perspective view of the metal ring of FIG. 11;

FIG. 13 is a stretched out view of a further metal plate for forming a metal ring of a motor rotor of a fourth embodiment according to the preferred teachings of the present invention;

FIG. 14 is a perspective view of the metal ring of FIG. 13

FIG. 15 is a stretched out view of a further metal plate for forming a metal ring of a motor rotor of a fifth embodiment according to the preferred teachings of the present invention;

FIG. 16 is a perspective view of formation of the metal ring of FIG. 15;

FIG. 17 is a partial, cross-sectional view of the motor rotor of FIG. 5 after assembly; and

FIG. 18 is another partial, cross-sectional view of the motor rotor of FIG. 5 after assembly.

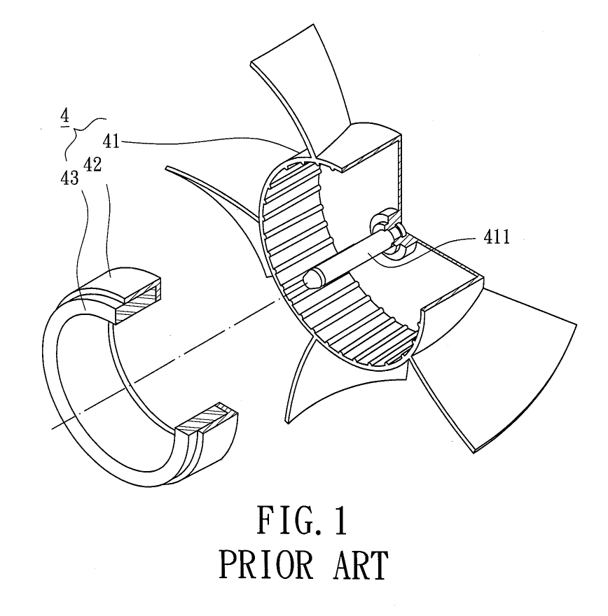

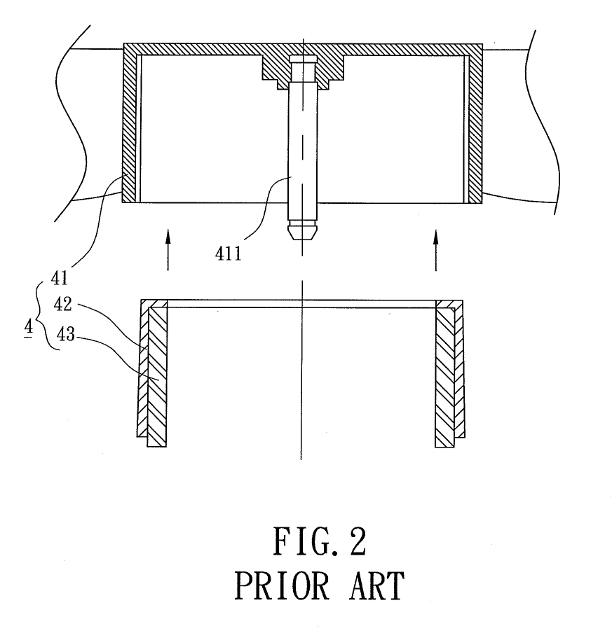

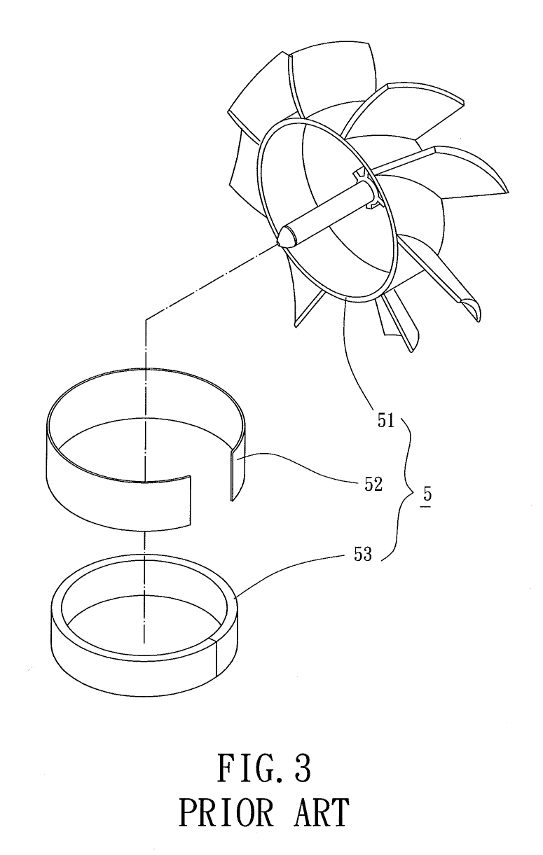

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “end”, “portion”, “section”, “axial”, “radial”, “annular”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

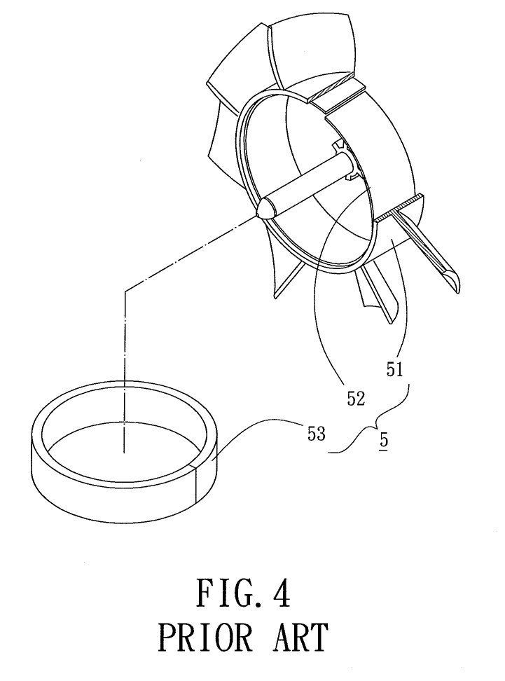

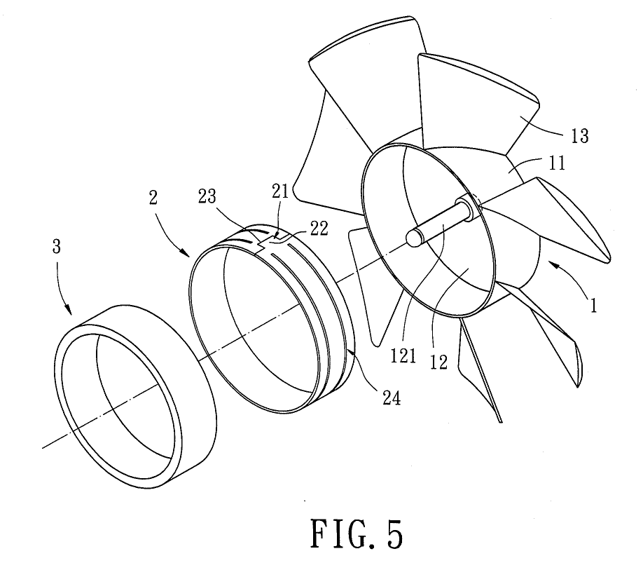

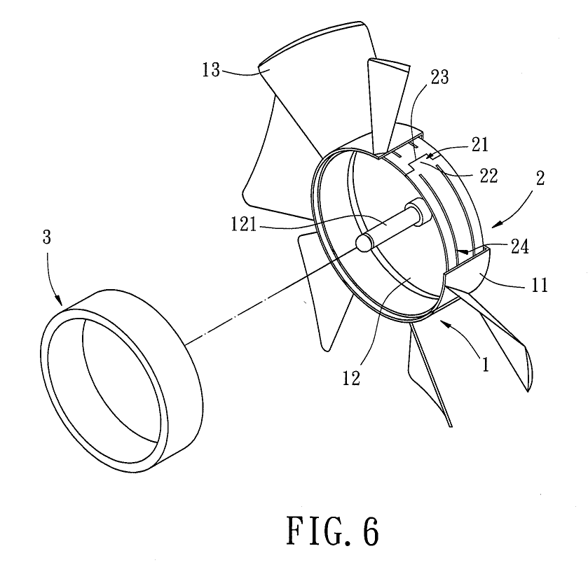

A motor rotor of a first embodiment according to the preferred teachings of the present invention is shown in FIGS. 5 and 6 of the drawings. According to the first embodiment form shown, the motor rotor includes a hub 1, a metal ring 2, and a magnet ring 3. The metal ring 2 and the magnet ring 3 are mounted in the hub 1, with the metal ring 2 being arranged between the hub 1 and the magnet ring 3 to provide a leakage flux absorbing effect for the magnet ring 3. Thus, the motor rotor according to the preferred teachings of the present invention can be coupled with a stator to form a motor.

The hub 1 includes a peripheral wall 11 and a closed end wall 12 on an end of the peripheral wall 11 to seal the end of the peripheral wall 11, with the other end of the peripheral wall 11 being open. A shaft 121 is mounted to a center of the closed end wall 12 and extends into an interior space defined by the peripheral wall 11. Besides, a plurality of vanes 13 is formed on an outer surface of the peripheral wall 11 of the hub 1 to form an impeller of a fan.

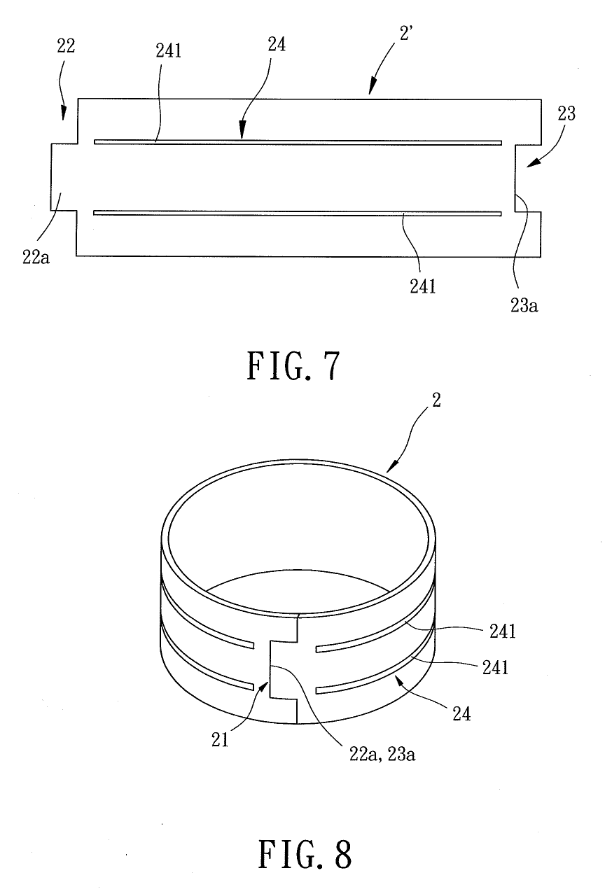

The metal ring 2 includes an engaging portion 21 and is formed by bending a strip of metal plate 2′ (as shown in FIGS. 7, 9, 11, 13 and 15) to form a cylindrical ring. The metal plate 2′ includes a first positioning portion 22 and a second positioning portion 23 respectively on two ends thereof. The first and second positioning portions 22 and 23 can be joined together by protrusion-and-groove engagement, clasping, riveting or welding, so that the engaging portion 21 is formed at a coupling area of the first and second positioning portions 22 and 23 to assure stable formation of the cylindrical metal ring 2. Furthermore, a coupling section 24 is formed on an outer radial face of the metal ring 2 to increase coupling area between the hub 1 and the metal ring 2, so that reliability of combination of the hub 1 and the metal ring 2 is enhanced.

The magnet ring 3 can be made of a strip of plastic magnet or rubber magnetic, or a strip of magnet made of an appropriate material, with two ends of the strip of magnet coupling with each other to form a cylindrical ring. And the magnet ring 3 is mounted to an inner radial surface of the metal ring 2.

Referring to FIG. 7, a part of the first positioning portion 22 of the metal plate 2′ forms a protrusion 22a, and a part of the second positioning portion 23 of the metal plate 2′ forms a groove 23a. With the metal plate 2′ being bent to form a cylindrical ring, the protrusion 22a is coupled in the groove 23a to jointly form the engaging portion 21, as shown in FIG. 8. The engaging portion 21 can be fixed by riveting to assure a stable cylindrical metal ring 2.

The followings are other embodiments according to the preferred teachings of the present invention. It is noted that the major difference between all embodiments is configurations of the first and second positioning portions 22 and 23.

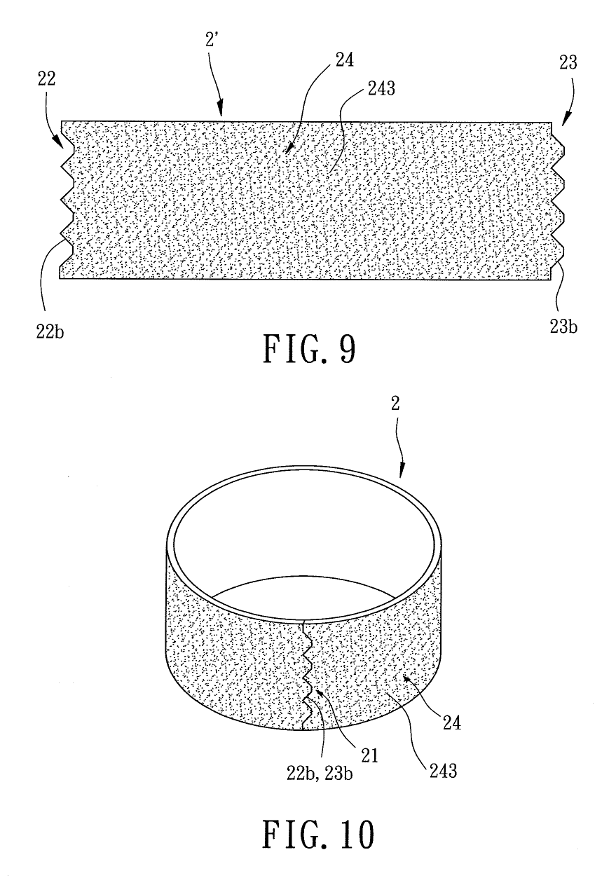

FIGS. 9 and 10 show a motor rotor of a second embodiment according to the preferred teachings of the present invention. In the preferred form shown, the first positioning portion 22 of the metal plate 2′ is serrated and includes a plurality of protrusions 22b, and the second positioning portion 23 of the metal plate 2′ is also serrated and includes a plurality of grooves 23b facing the protrusions 22b respectively. Turning to FIG. 10, after the metal plate 2′ is bent to form a cylindrical ring, the protrusions 22b are coupled in the grooves 23b, so that the first and second positioning portions 22 and 23 can engage with each other more reliably. Thus, the engaging portion 21 is formed to provide a stable cylindrical metal ring 2.

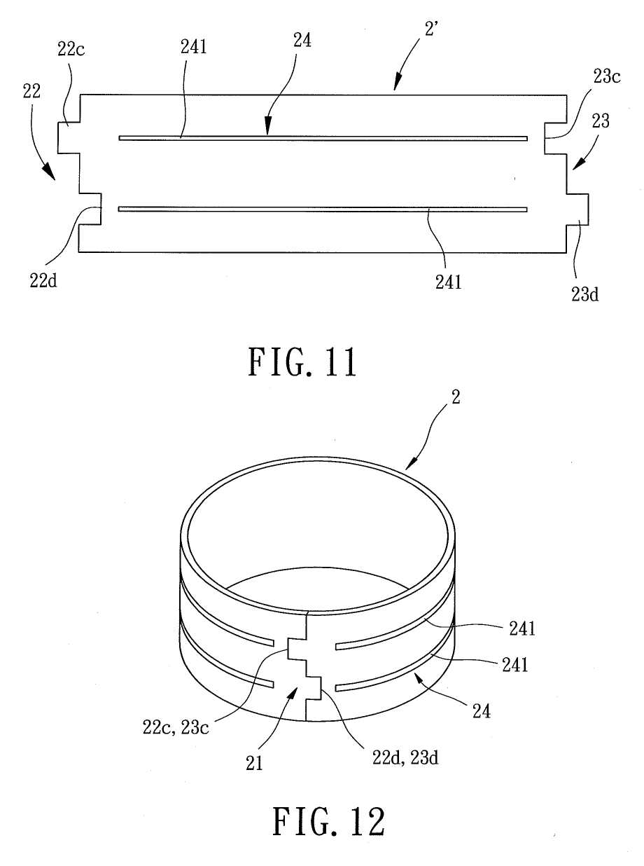

A motor rotor of a third embodiment according to the preferred teachings of the present invention is shown in FIGS. 11 and 12 of the drawings. According to the third embodiment form shown, the first positioning portion 22 of the metal plate 2′ includes a first protrusion 22c and a first groove 22d, and the second positioning portion 23 of the metal plate 2′ includes a second groove 23c facing the first protrusion 22c and a second protrusion 23d facing the first groove 22d. Turning to FIG. 12, after the metal plate 2′ is bent to form a cylindrical ring, the first and second protrusions 22c and 23d are respectively coupled in the second and first grooves 23c and 22d, so that the first and second positioning portions 22 and 23 jointly provide a dual engaging function to form the engaging portion 21. Therefore, the two ends of the metal plate 2′ shifting relative to each other in an axial direction of the hub 1 is avoided.

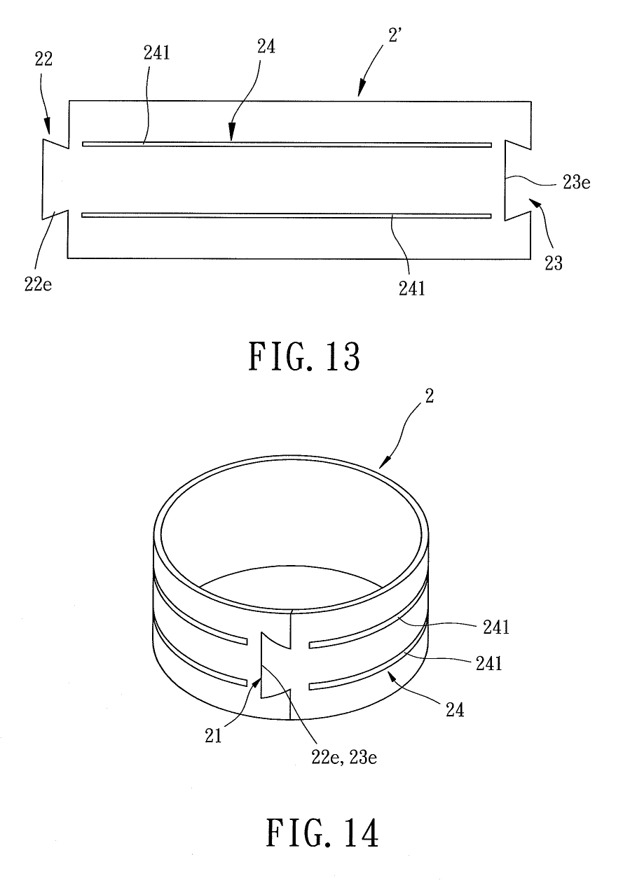

FIG. 13 shows a motor rotor of a fourth embodiment according to the preferred teachings of the present invention. In the preferred form shown, the first positioning portion 22 of the metal plate 2′ includes a protrusion 22e and the second positioning portion 23 of the metal plate 2′ includes a groove 23e facing the protrusion 22e. Specifically, the protrusion 22e and the groove 23e fit each other while the protrusion 22e is in the shape of a turtledove tail. Turning to FIG. 14, after the metal plate 2′ is bent to form a cylindrical ring, the turtledove tail protrusion 22e is coupled in the turtledove tail groove 23e to jointly form the engaging portion 21. By the protrusion-and-groove engagement of the protrusion 22e and the groove 23e, two ends of the metal plate 2′ are fastened to assuredly keep the metal ring 2 in the shape of a cylindrical ring. Therefore, as shown in FIG. 6, the metal ring 2 can be easily mounted to an inner surface of the peripheral wall 11 of the hub 1 to enhance convenience of assembling.

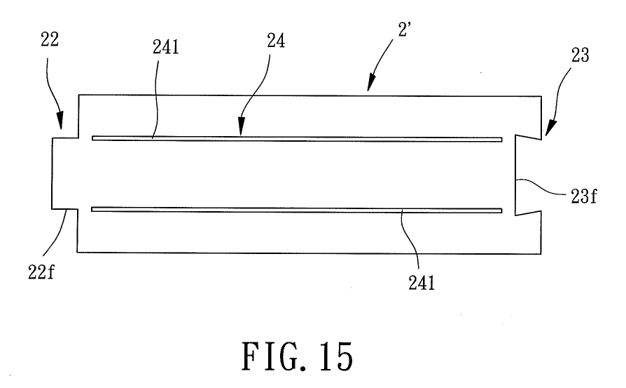

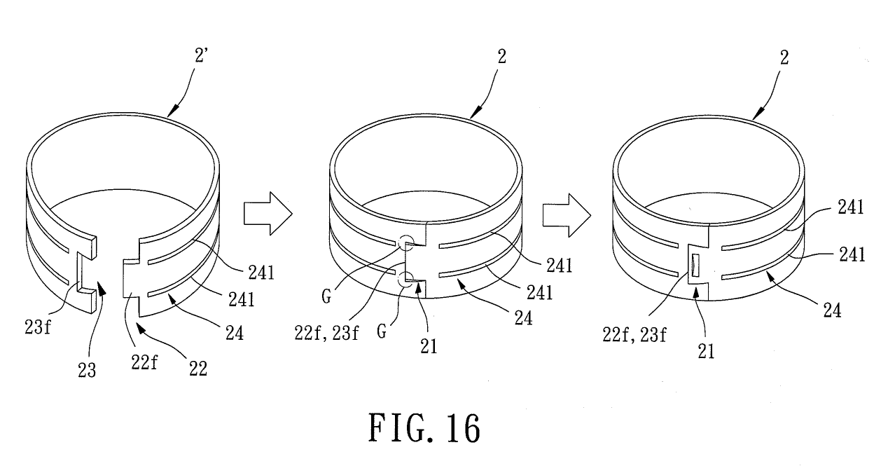

A motor rotor of a fifth embodiment according to the preferred teachings of the present invention is shown in FIG. 15 of the drawings. According to the fifth embodiment form shown, the first positioning portion 22 of the metal plate 2′ includes a rectangular protrusion 22f, and the second positioning portion 23 of the metal plate 2′ includes a turtledove-tail-shaped groove 23f facing the rectangular protrusion 22f. Turning to FIG. 16, after the metal plate 2′ is bent to form a cylindrical ring, the rectangular protrusion 22f is coupled in the turtledove-tail-shaped groove 23f to jointly form the engaging portion 21. It is noted that an opening of the turtledove-tail-shaped groove 23f is wider than a bottom thereof. Furthermore, there is a gap “G” formed between each of two opposite end edges of the rectangular protrusion 22f and each of two opposite peripheries of the turtledove-tail-shaped groove 23f. Preferably, the rectangular protrusion 22f can be punched to cause deformation for filling the gaps “G”, so that the rectangular protrusion 22f is tightly coupled in the turtledove-tail-shaped groove 23f to provide more reliable engagement.

Moreover, in addition to several different configurations of the first and second positioning portions 22 and 23, which have been discussed above, there are various designs of the coupling section 24 to increase the coupling area between the hub 1 and the metal ring 2 to further fix combination of the hub 1 and the metal ring 2 and the various designs are as follows.

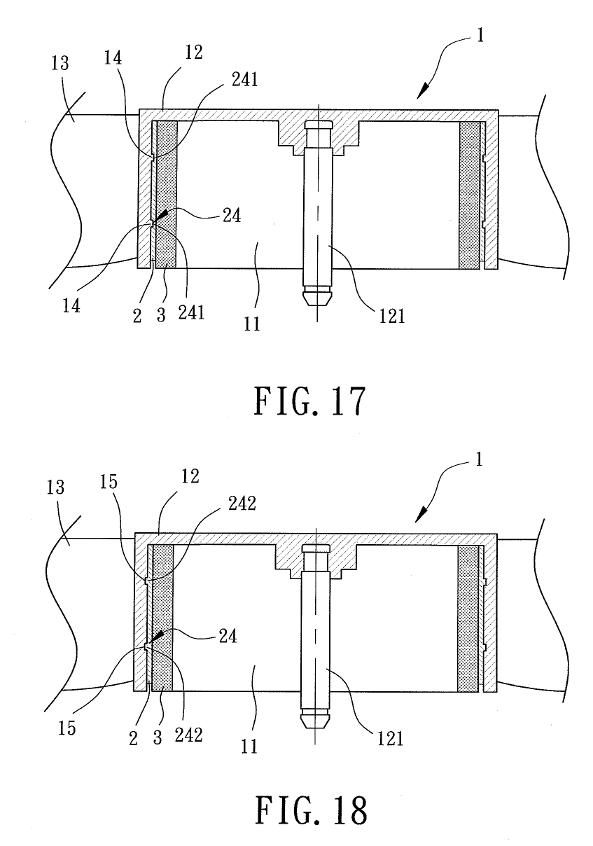

Referring again to FIGS. 7 and 8 (FIGS. 11 to 16 as well), the coupling section 24 of the metal ring 2 is in the form of a plurality of grooves 241 extending from the first positioning portion 22 to the second positioning portion 23. Additionally, the peripheral wall 11 of the hub 1 includes a plurality of annular ribs 14 on an inner face thereof, as shown in FIG. 17. The annular ribs 14 are coupled in the grooves 241 to increase the coupling area between the hub 1 and the metal ring 2, so that the hub 1 and the metal ring 2 are combined more reliably and tightly.

Alternatively, now turning to FIG. 18, the coupling section 24 of the metal ring 2 is in the form of a plurality of ribs 242 extending from the first positioning portion 22 to the second positioning portion 23. The peripheral wall 11 of the hub 1 includes a plurality of annular grooves 15 in the inner face thereof. The ribs 242 are coupled in the annular grooves 15 to increase the coupling area between the hub 1 and the metal ring 2 as well, so that tightness and reliability of the combination of the hub 1 and the metal ring 2 are enhanced.

Now turning back to FIGS. 9 and 10, the coupling section 24 of the metal ring 2 is in the form of a rugged face 243 to further increase the coupling area between the hub 1 and the metal ring 2, and thus enhanced positioning effect is provided to join the hub 1 and the metal ring 2 more reliably and tightly.

It can be appreciated that the above-mentioned examples of the coupling section 24 can be selectively combined with the above-mentioned examples of the first and second positioning portions 22 and 23 to provide various combinations those form motor rotors with improved functions. For example, the metal ring 2 having a single protrusion and a single groove, namely the protrusion 22a and the groove 23a, can include the grooves 241, the ribs 242, or the rugged face 243. As another example, the metal ring 2 having serrated positioning portions 22b and 23b can include the grooves 241, the ribs 242, or the rugged face 243.

As has been discussed above, because the metal ring 2 of the motor rotor according to the preferred teachings of the present invention is formed by bending a strip of metal plate 2′, there is no waste material and it is easy to manufacture the motor rotor. Furthermore, two ends of the metal plate 2′ form the first and second positioning portions 22 and 23 those are fastened together to prevent the two ends of the metal plate 2′ from shifting in the axial direction of the hub 1. Therefore, after the metal plate 2′ is bent to form a cylindrical ring, the engaging portion 21 formed by the first and second positioning portions 22 and 23 assures a stable cylindrical metal ring 2 to enhance convenience of assembling and provide improved rotational stability of a motor formed by coupling a stator with the motor rotor according to the preferred teachings of the present invention. Besides, the coupling section 24 on the outer radial surface of the metal ring 24 provides enhanced positioning effect between the hub 1 and the metal ring 2 to ensure quality of the motor rotor according to the preferred teachings of the present invention.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A motor rotor comprising:
a hub including a peripheral wall;
a metal ring including an engaging portion and being formed by bending a strip of metal plate to form a cylindrical ring mounted to an inner surface of the peripheral wall of the hub, with the metal plate including a first positioning portion and a second positioning portion respectively on two ends thereof, with the first and second positioning portions being joined together to form the engaging portion; and
a magnet ring mounted to an inner radial surface of the metal ring.

2. The motor rotor as defined in claim 1, wherein a coupling section is formed on an outer radial face of the metal ring coupling to the inner surface of the peripheral wall of the hub.

3. The motor rotor as defined in claim 2, wherein the coupling section of the metal ring is in the form of a plurality of grooves and the peripheral wall of the hub includes a plurality of annular ribs on the inner face thereof, with the annular ribs being coupled in the grooves.

4. The motor rotor as defined in claim 2, wherein the coupling section of the metal ring is in the form of a plurality of ribs coupled in a plurality of annular grooves which is in the inner surface face of the peripheral wall of the hub.

5. The motor rotor as defined in claim 2, wherein the coupling section of the metal ring is in the form of a rugged face coupling to the inner surface of the peripheral wall of the hub.

6. The motor rotor as defined in claim 1, wherein a part of the first positioning portion forms a protrusion, and a part of the second positioning portion forms a groove facing the protrusion of the first positioning portion.

7. The motor rotor as defined in claim 1, wherein the first positioning portion is serrated and includes a plurality of protrusions and the second positioning portion is serrated and includes a plurality of grooves facing the protrusions respectively.

8. The motor rotor as defined in claim 1, wherein the first positioning portion includes a first protrusion and a first groove, and the second positioning portion includes a second groove facing the first protrusion and a second protrusion facing the first groove.

9. The motor rotor as defined in claim 1, wherein the first positioning portion includes a protrusion and the second positioning portion includes a groove facing the protrusion, with the protrusion and the groove fitting each other while the protrusion is in the shape of a turtledove tail.

10. The motor rotor as defined in claim 1, wherein the first positioning portion includes a rectangular protrusion, and the second positioning portion includes a turtledove-tail-shaped groove facing the rectangular protrusion.

11. The motor rotor as defined in claim 1, wherein the hub further includes a closed end wall on an end of the peripheral wall to seal the end of the peripheral wall, and a shaft is mounted to a center of the closed end wall and extends into an interior space defined by the peripheral wall.

12. The motor rotor as defined in claim 1, wherein a plurality of vanes is formed on an outer surface of the peripheral wall of the hub.

13. A metal ring for motor rotor comprising an engaging portion and being formed by bending a strip of metal plate to form a cylindrical ring, with the metal plate including a first positioning portion and a second positioning portion respectively on two ends thereof, with the first and second positioning portions being joined together to form the engaging portion.

14. The metal ring for motor rotor as defined in claim 13, wherein a coupling section is formed on an outer radial face of the metal ring.

15. The metal ring for motor rotor as defined in claim 14, wherein the coupling section of the metal ring is selected from a plurality of grooves, a plurality of annular ribs or a rugged face.

16. The metal ring for motor rotor as defined in claim 13, wherein a part of the first positioning portion forms a protrusion, and a part of the second positioning portion forms a groove facing the protrusion of the first positioning portion.

17. The metal ring for motor rotor as defined in claim 13, wherein the first positioning portion is serrated and includes a plurality of protrusions and the second positioning portion is serrated and includes a plurality of grooves facing the protrusions respectively.

18. The metal ring for motor rotor as defined in claim 13, wherein the first positioning portion includes a first protrusion and a first groove, and the second positioning portion includes a second groove facing the first protrusion and a second protrusion facing the first groove.

19. The metal ring for motor rotor as defined in claim 13, wherein the first positioning portion includes a protrusion and the second positioning portion includes a groove facing the protrusion, with the protrusion and the groove fitting each other while the protrusion is in the shape of a turtledove tail.

20. The metal ring for motor rotor as defined in claim 13, wherein the first positioning portion includes a rectangular protrusion, and the second positioning portion includes a turtledove-tail-shaped groove facing the rectangular protrusion.
